(19) United States
(12) Patent Application Publication
(10) Pub. No.: US 2026/0279682 A1
(43) Pub. Date: Sep. 17, 2026

(54) MULTILAYER CERAMIC ELECTRONIC COMPONENT

(71) Applicant: TAIYO YUDEN CO., LTD., Tokyo (JP)

(72) Inventor: Yuta SAITO, Tokyo (JP)

(21) Appl. No.: 19/548,343

(22) Filed: Feb. 24, 2026

(30) Foreign Application Priority Data
Mar. 13, 2025 (JP) 2025-040709

(51) Int. Cl. H01G 4/30; H01G 4/12

(52) U.S. Cl. CPC H01G 4/30; H01G 4/12

(57) ABSTRACT

A multilayer ceramic electronic component is provided and includes a body including a plurality of dielectric layers and a plurality of internal electrode layers that are alternately laminated along a first axis. The internal electrode layers are drawn outward from both ends of the body along a second axis orthogonal to the first axis. The body includes side margins at both ends of the body along a third axis orthogonal to the first axis and the second axis. At least one of the side margins includes one or more secondary phases connecting an outer surface of a capacitor portion to an outer surface of the at least one of the side margins. The capacitor portion includes the internal electrode layers and the dielectric layers that are alternately laminated.

### CROSS-REFERENCE TO RELATED APPLICATIONS

This patent application is based on and claims priority to Japanese Patent Application No. 2025-040709 filed on Mar. 13, 2025, the entire contents of which are incorporated herein by reference.

### TECHNICAL FIELD

The present disclosure relates to a multilayer ceramic electronic component.

### BACKGROUND

Multilayer ceramic electronic components have a structure in which dielectric layers and internal electrode layers are alternately laminated. Examples of the multilayer ceramic electronic components include a multilayer ceramic capacitor (MLCC) and the like.

The multilayer ceramic electronic components, such as the multilayer ceramic capacitor and the like, are mounted in various electronic devices, such as, for example, high-frequency communication systems including portable phones, and in-vehicle electronic control devices. Therefore, various performance improvements are needed for multilayer ceramic electronic components, and studies have been conducted (see, for example, Patent Document 1).

### RELATED ART DOCUMENT

### Patent Document

Patent Document 1: Japanese Laid-Open Patent Application Publication No. 2023-158176

### SUMMARY

A multilayer ceramic electronic component according to the present disclosure includes a body including a plurality of dielectric layers and a plurality of internal electrode layers that are alternately laminated along a first axis. The internal electrode layers are drawn outward from both ends of the body along a second axis orthogonal to the first axis. The body includes side margins at both ends of the body along a third axis orthogonal to the first axis and the second axis. At least one of the side margins includes one or more secondary phases connecting an outer surface of a capacitor portion to an outer surface of the at least one of the side margins. The capacitor portion includes the internal electrode layers and the dielectric layers that are alternately laminated.

### BRIEF DESCRIPTION OF THE DRAWINGS

FIG. 1 is a partial cross-sectional perspective diagram illustrating a multilayer ceramic capacitor according to an embodiment of the present disclosure.

FIG. 2 is a cross-sectional diagram illustrating the multilayer ceramic capacitor according to the embodiment of the present disclosure.

FIG. 3 is a cross-sectional diagram illustrating the multilayer ceramic capacitor according to the embodiment of the present disclosure.

FIG. 4 is a cross-sectional diagram illustrating details of a side margin according to the embodiment of the present disclosure.

FIG. 5 is a flowchart of a production method of the multilayer ceramic capacitor according to the embodiment of the present disclosure.

FIG. 6A and FIG. 6B are examples of the production method of the multilayer ceramic capacitor according to the embodiment of the present disclosure.

### DETAILED DESCRIPTION

The multilayer ceramic electronic components are mounted in various electronic devices, and various performance improvements are needed. Especially, in recent years, there has been a need for a multilayer ceramic electronic component having a low crack forming rate even after the multilayer ceramic electronic component is operated with a voltage applied.

According to the present disclosure, it is possible to provide a multilayer ceramic electronic component having a low crack forming rate.

Hereinafter, embodiments of the present disclosure will be described in detail, but the present disclosure is not limited thereto. In the present specification and drawings, components having substantially the same functional configuration may be denoted by the same reference numerals to omit duplicate descriptions. Also, in the drawings, mutually orthogonal X, Y, and Z axes are shown as appropriate. The X, Y, and Z axes define a fixed coordinate system fixed to a multilayer ceramic capacitor, which is an example of a multilayer ceramic electronic component. The X, Y, and Z axes may correspond to the length, width, and height of a multilayer ceramic capacitor, which is an example of a multilayer ceramic electronic component, when the multilayer ceramic capacitor has an approximately rectangular parallelepiped outer shape. The multilayer ceramic electronic component of the present embodiment will be described below using a multilayer ceramic capacitor, which is an example of the multilayer ceramic electronic component.

### [Multilayer Ceramic Electronic Component]

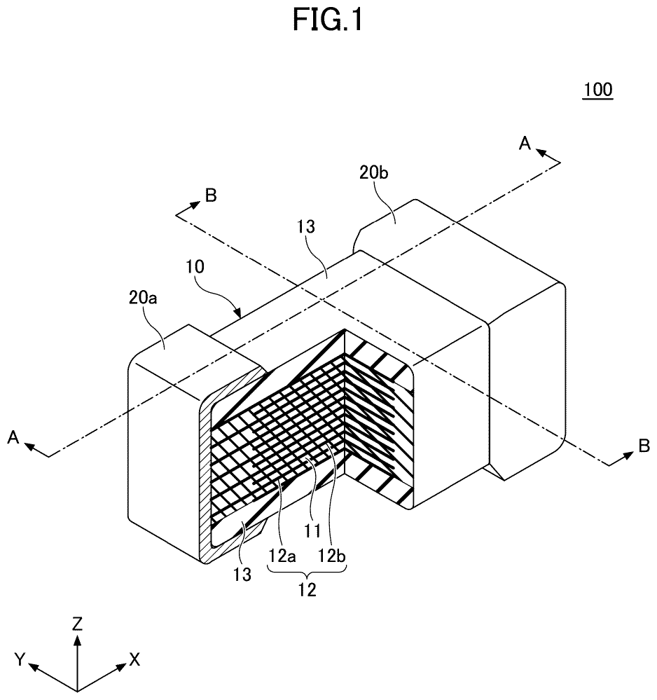

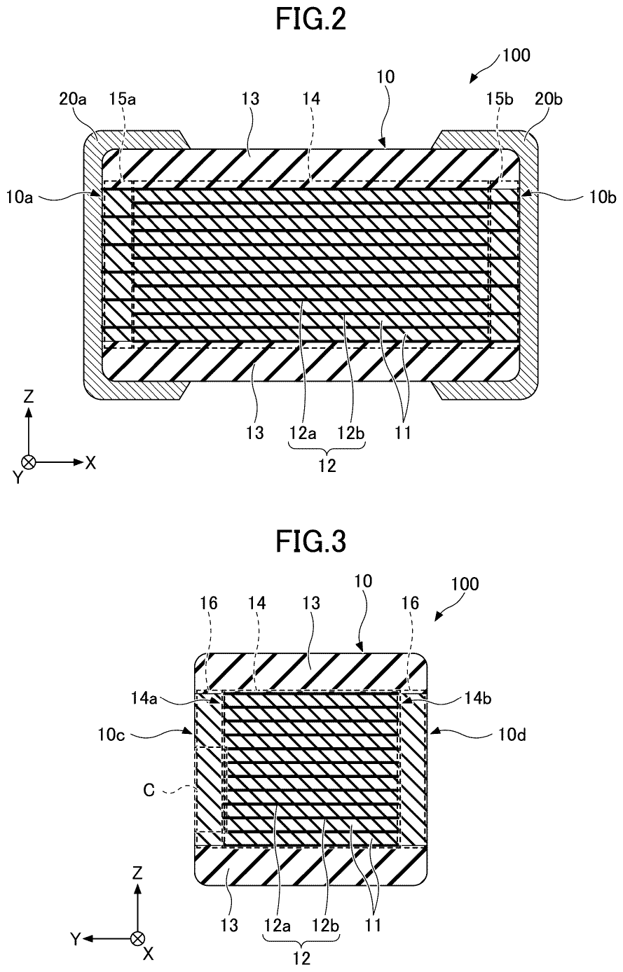

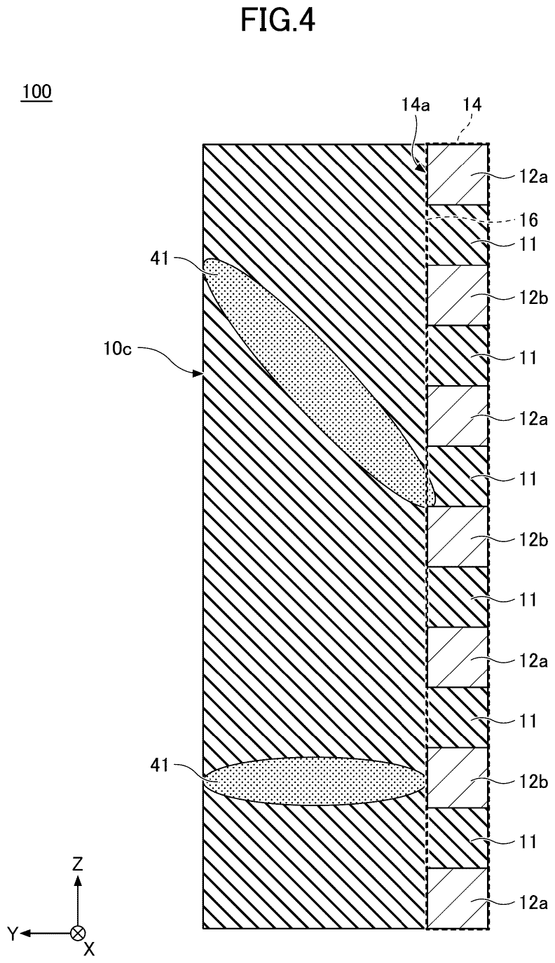

(1) Structure of Multilayer Ceramic Electronic Component FIG. 1 is a partial cross-sectional perspective diagram illustrating a multilayer ceramic capacitor 100. FIGS. 2 and 3 are cross-sectional diagrams illustrating the multilayer ceramic capacitor 100. FIG. 2 is a cross-sectional diagram taken along the line A-A in FIG. 1. FIG. 3 is a cross-sectional diagram taken along the line B-B in FIG. 1. As illustrated in FIGS. 1 to 3, the multilayer ceramic capacitor 100 includes a body 10 having a substantially rectangular parallelepiped shape. Two surfaces included in the outer surfaces of the body 10 and facing each other are referred to as an upper surface and a lower surface, and four surfaces connecting the upper surface and the lower surface are referred to as side surfaces. Typically, but non-limitatively, a surface of the multilayer ceramic capacitor that is on the circuit board side when mounting the multilayer ceramic capacitor on the circuit board is referred to as the lower surface, In the examples illustrated in FIGS. 1 to 3, the body 10 is provided with a first external electrode 20a and a second external electrode 20b on a first side surface 10a and a second side surface 10b (see FIG. 2), which are two facing side surfaces. The first external electrode 20a extends from the first side surface 10a to four adjacent surfaces. The second external electrode 20b extends from the second side surface 10b to four adjacent surfaces. The first external electrode 20a and the second external electrode 20b are spaced apart from each other. The external electrodes may be provided not only on the two facing side surfaces but also anywhere on the outer surfaces of the body 10.

The lamination direction in which dielectric layers 11 and internal electrode layers 12 are laminated is along a first axis. In FIGS. 1 to 3, the first axis along the lamination direction in which the dielectric layers 11 and the internal electrode layers 12 are laminated, is a Z axis along a direction in which the internal electrode layers face each other.

An axis perpendicular to the first axis along the lamination direction is a second axis. In FIGS. 1 to 3, the second axis, which is the axis perpendicular to the first axis along the lamination direction, is an X axis. The second axis is along the length direction of the body 10, and is along a direction in which the first side surface 10a and the second side surface 10b of the body 10 face each other, and a direction in which the first external electrode 20a and the second external electrode 20b face each other.

An axis perpendicular to the first axis along the lamination direction and perpendicular to the second axis is a third axis. The third axis is along the width of the internal electrode layers 12. In FIGS. 1 to 3, the third axis perpendicular to the first axis along the lamination direction and perpendicular to the second axis is a Y axis. The third axis is an axis along the direction in which a third side surface 10c and a fourth side surface 10d, which are two side surfaces other than the first side surface 10a and the second side surface 10b among the four side surfaces of the body 10, face each other (see FIG. 3). The X axis, the Y axis, and the Z axis are orthogonal to each other.

The lamination direction is not limited to the Z direction, and can be any direction. Therefore, for example, the first axis along the lamination direction may be the X axis in the X direction or the Y axis in the Y direction.

In the present specification, a diagram illustrating one specific embodiment may be used to describe a general embodiment. However, the contents described based on the coordinate system used in one embodiment are applicable to general embodiments by reading the coordinate system in the one embodiment as a general coordinate system in which the lamination direction is along the first axis. For example, those that are used in FIGS. 1 to 3 relating to one specific embodiment, in which the lamination direction coincides with the Z direction, and that are referred to as the X axis, the Y axis, and the Z axis are applicable to general embodiments by being read as the second axis, the third axis, and the first axis in the general embodiments.

The body 10 has a configuration in which the dielectric layers 11, containing a ceramic material functioning as a dielectric material, and the internal electrode layers 12 are alternately laminated. The internal electrode layers 12 include a plurality of first internal electrode layers 12a and a plurality of second internal electrode layers 12b. The first internal electrode layers 12a and the second internal electrode layers 12b sandwich the dielectric layers 11 to form a capacitor portion 14 of a laminate in which the first internal electrode layers 12a and the second internal electrode layers 12b are alternately laminated. The edges of the first internal electrode layers 12a are drawn to the surface of the body 10 on which the first external electrode 20a is provided, which is the first side surface 10a in the examples of FIGS. 1 to 3. The edges of the second internal electrode layers 12b are drawn to the surface of the body 10 on which the second external electrode 20b is provided, which is the second side surface 10b in the examples of FIGS. 1 to 3. That is, the internal electrode layers 12 are drawn outward from both ends of the body 10 along the X axis, i.e., the second axis. Thus, the first internal electrode layers 12a and the second internal electrode layers 12b are in electrical conduction with the first external electrode 20a and the second external electrode 20b alternately. Therefore, the multilayer ceramic capacitor 100 has a configuration in which capacitor units are laminated. In the capacitor portion 14 of the dielectric layers 11 and the internal electrode layers 12, the internal electrode layers 12 are positioned as the outermost layers in the lamination direction, and the outer surfaces of the laminate in the lamination direction, which are the upper surface and the lower surface in the examples of FIGS. 1 to 3, are covered by cover layers 13. The cover layers 13 contain a ceramic material as a main component. For example, the cover layers 13 may have a composition that is the same as or different from that of the dielectric layers 11. The configuration illustrated in FIGS. 1 to 3 is non-limiting, as long as the first internal electrode layers 12a and the second internal electrode layers 12b are exposed to different regions among the surfaces of the laminate and are in electrical conduction with different external electrodes. The different regions among the surfaces of the laminate may be surface regions included in facing surfaces of the laminate, may be surface regions included in adjacent surfaces of the laminate, or may be different surface regions included in the same surface of the laminate. As long as the different external electrodes are spaced from each other, the external electrodes may extend from the surfaces of the laminate, which include the surface regions to which the first internal electrode layers 12a and the second internal electrode layers 12b are exposed, to any other surface.

As illustrated in FIG. 2, a region where the first internal electrode layers 12a connected to the first external electrode 20a and the second internal electrode layers 12b connected to the second external electrode 20b face each other is a region where the electric capacitance is generated in the multilayer ceramic capacitor 100. Therefore, the region where the electric capacitance is generated is referred to as the capacitor portion 14. That is, in the laminate, the capacitor portion 14 is a region where the internal electrode layers connected to the different external electrodes and adjacent to each other across the dielectric layers 11 face each other.

A region where the first internal electrode layers 12a connected to the first external electrode 20a face each other in the lamination direction via no second internal electrode layers 12b connected to the second external electrode 20b is referred to as a first end margin 15a (see FIG. 2). A region where the second internal electrode layers 12b connected to the second external electrode 20b face each other in the lamination direction via no first internal electrode layers 12a connected to the first external electrode 20a is referred to as a second end margin 15b. Each end margin is a region where the internal electrode layers connected to the same external electrode face each other in the lamination direction via no internal electrode layers connected to the different external electrode. The first end margin 15a and the second end margin 15b are regions where the internal electrodes having the same potential face each other and substantially no electric capacitance is generated.

Side margins 16 are regions provided on the outer sides of the capacitor portion 14 along the third axis perpendicular to the lamination direction and the second axis, i.e., in the direction along the Y axis in the example of FIG. 3. That is, the side margins 16 are outer regions adjacent to the capacitor portion 14 as viewed in the lamination direction, and are outer regions adjacent to the capacitor portion 14 on the sides to which the internal electrode layers 12 are not drawn outward. The side margins 16 are also regions in which no electric capacitance is generated. The side margins 16 can contain a ceramic material as a main component. For example, the side margins 16 may have a composition that is the same as or different from that of the dielectric layers 11. As described below, the side margins 16 can contain one or more secondary phases having a composition different from that of the dielectric material in addition to the dielectric material. The side margins 16 may contain the secondary phases in an amount larger than in the dielectric layers 11. In terms of the area of the secondary phases in a cross section of the multilayer ceramic capacitor 100 including the lamination direction, the side margin 16 may be 1.1 times or more larger than the dielectric layers 11. The secondary phases may be identified based on the difference in brightness in SEM analysis. Alternatively, the secondary phases may be identified based on regions where elements in the secondary phases are concentrated in an element map obtained through SEM-EDS analysis.

No particular limitation is imposed on the size of the multilayer ceramic capacitor 100, and the size of the multilayer ceramic capacitor 100 may be, for example: 0.25 millimeters (mm) in length, 0.125 mm in width, and 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. The above-listed sizes of the multilayer ceramic capacitor 100 are merely examples, and the multilayer ceramic capacitor 100 is not limited to the above sizes. The sizes of the multilayer ceramic capacitor 100 may be in the relationship of, for example, length>width≥height, width>length>height, height>length≥width, or height>width≥length. For example, the length represents the size in the X-axis direction, the width represents the size in the Y-axis direction, and the height represents the size in the Z-axis direction.

As described above, the multilayer ceramic capacitor 100 of the present embodiment includes the body 10 in which the dielectric layers 11 and the internal electrode layers 12 are alternately laminated along the Z axis, i.e., the first axis.

The internal electrode layers 12 can be drawn outward from both ends along the X axis, i.e., the second axis orthogonal to the first axis. That is, the internal electrode layers 12 can be drawn outward from the first side surface 10a.

The body 10 includes the side margins 16 at both ends along the Y axis, i.e., the third axis orthogonal to the first axis and the second axis.

Each component will be described below.

In the present specification, numbers, such as “first”, “second”, and the like, are sometimes added to the names of members, like the first internal electrode layer and the second internal electrode layer. The addition of the numbers is just for designating members to describe and for avoiding confusion, and does not indicate priority, arrangement, or the like. Therefore, when there is no possibility of confusion or when the members are collectively referred to, the members can be simply referred to as internal electrode layers.

### (2) Dielectric Layer

The dielectric layers 11 can contain a dielectric material. The dielectric material contained in the dielectric layers 11 may be, for example, a compound having a perovskite structure represented by general formula ABO_{3-α} (0≤α≤1). “A” and “B” in the general formula denote an element located at an A site and an element located at a B site, respectively.

### (2-1) Components Having Perovskite Structure

When having a stoichiometric composition, a compound having a perovskite structure is represented by the general formula ABO₃, with α, which represents the amount of deviation from the stoichiometric composition, being 0. The compound having a perovskite structure represented by the above general formula may have a that is greater than 0 and is equal to or less than 1. That is, the compound having the perovskite structure represented by the above general formula may be more oxygen-deficient than the stoichiometric composition.

As the compound having the perovskite structure, one or more selected from barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}Zr_{z}O₃ (0≤x≤1, 0≤y≤1, 0≤z≤1) forming a perovskite structure, and the like can be used.

Examples of Ba_{1-x-y}CaₓSr_{y}Ti_{1-z}Zr_{z}O₃ include barium strontium titanate, barium calcium titanate, barium zirconate, barium zirconate titanate, calcium zirconate titanate, barium calcium zirconate titanate, and the like. The compound having the perovskite structure may contain oxygen deficiency regardless of the type of the material.

It is preferable that the dielectric layers 11 contain barium titanate having particularly excellent dielectric characteristics as the compound having the perovskite structure, and may contain barium titanate as a main component, or may be composed only of barium titanate. Barium titanate has excellent dielectric characteristics, such as an extremely high dielectric constant, a low dielectric loss, and the like. Therefore, when the dielectric layer 11 contains barium titanate as the compound having the perovskite structure, the capacitance of the multilayer ceramic capacitor 100 can be increased. In the present specification, “containing as a main component” means that the component is contained in the highest amount in terms of the ratio by mole, among the components contained.

The dielectric layers 11 may contain the compound having the perovskite structure as a main component. For example, the dielectric layer 11 may contain the compound having the perovskite structure in an amount of 50% by mole or more, or 90% by mole or more.

### (Additive)

The dielectric layers 11 may contain an additive as an optional component.

No particular limitation is imposed on the additive that can be contained in the dielectric layers 11. Examples of the additive include, for example: compounds, such as oxides and carbonates containing one or more elements selected from zirconium (Zr), magnesium (Mg), manganese (Mn), molybdenum (Mo), vanadium (V), chromium (Cr), and rare earth elements; compounds, such as oxides and carbonates containing one or more elements selected from cobalt (Co), nickel (Ni), lithium (Li), boron (B), sodium (Na), potassium (K), calcium (Ca), aluminum (Al), and silicon (Si); and glass containing one or more elements selected from cobalt, nickel, lithium, boron, sodium, potassium, and silicon.

No particular limitation is imposed on the rare earth elements, and the rare earth elements for use can be one or more selected from scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb).

### (2-2) Thickness of Dielectric Layer

No particular limitation is imposed on the thickness of the dielectric layer 11. From the viewpoint of increasing the number of layers to be laminated while reducing the size of the multilayer ceramic capacitor 100, the thickness of the dielectric layer 11 may be, for example, 1.0 micrometer (μm) or less, 0.8 μm or less, 0.5 μm or less, or 0.4 μm or less.

No particular limitation is imposed on the lower limit of the thickness of the dielectric layer 11. From the viewpoint of improving productivity and yield, the thickness of the dielectric layer 11 may be two to four times the average diameter of dielectric material particles used. For example, when the average diameter of the dielectric material particles used is 0.1 μm, the lower limit of the thickness of the dielectric layer 11 may be 0.2 μm or greater and 0.4 μm or less. For example, the thickness of the dielectric layer 11 may be 0.2 μm or greater or may be 0.4 μm or greater.

The average diameter of the dielectric material particles may be an average value of the particle diameters of the dielectric material particles measured in a cross section of the multilayer ceramic capacitor 100 including the first axis along the lamination direction of the multilayer ceramic capacitor 100. For the measurement of the particle diameters of the dielectric material particles, an optical microscope, a microscope, a scanning electron microscope (SEM), or the like may be used as appropriate. The particle diameter of the dielectric material particles can be the Heywood diameter (which is the diameter of a circle having an area equal to the area of the dielectric material particles evaluated) in a cross section observed. The average diameter, which is the average value of the particle diameters of the dielectric material particles, can be an arithmetic mean value of the particle diameters of 50 or more and 200 or less randomly selected dielectric material particles. In the present specification, the average value means the arithmetic mean value, unless otherwise specified.

In the evaluation of the thickness of the dielectric layer 11, the cross section including the first axis along the lamination direction is evaluated. For example, it is preferable to perform evaluation using a cross section further including the second axis set perpendicularly to the lamination direction, or a cross section further including the third axis set perpendicularly to the lamination direction and perpendicularly to the second axis, for ease with polishing and measurement. The multilayer ceramic capacitor 100 is polished in the third axis direction in the former case, and in the second axis direction in the latter case. Five layers are selected from each of the center part, the upper end part, and the lower end part of the exposed dielectric layers 11 in the first axis direction. When the number of dielectric layers 11 is even, six layers are selected from the center part. Then, the thickness is measured at a total of three positions of each of the selected dielectric layers, i.e., the center part, a left end part, and a right end part, and the average value of the measured thicknesses is used as the thickness of each dielectric layer 11. Furthermore, the average value of the thicknesses of all the selected and evaluated dielectric layers 11 can be used as the thickness of the dielectric layers 11 in the multilayer ceramic capacitor 100.

The examples illustrated in FIGS. 1 and 2, in which the first axis along the lamination direction is in the Z-axis direction, are examples in which the multilayer ceramic capacitor 100 is polished along the Y axis, i.e., the third axis, to expose an XZ surface in which the dielectric layers 11 and the internal electrode layers 12 are laminated.

In this case, from the exposed XZ surface, five dielectric layers 11 located at the center along the Z axis, i.e., the first axis, and five dielectric layers 11 located at each of the upper end and the lower end along the Z axis, i.e., the first axis, are selected. When the number of dielectric layers 11 is even, six layers may be selected from the center part. In this case, the dielectric layers 11 to be selected are selected from within the capacitor portion 14.

Then, the thickness of each selected dielectric layer 11 is measured along the X axis, i.e., the second axis, at three positions spaced apart from an end by ¼, ½, and ¾ the length of the dielectric layer 11 along the X axis, is averaged as the thickness of the dielectric layer 11. By the same procedure, the thicknesses of all the selected dielectric layers 11 are measured, and the average value of the thicknesses of all the selected and evaluated dielectric layers 11 can be used as the thickness of the dielectric layers 11 in the evaluated multilayer ceramic capacitor 100.

### (3) Internal Electrode Layer

### (3-1) Components Included in Internal Electrode Layer (Base Metal)

The internal electrode layers 12 can contain a base metal element as a main component.

The internal electrode layers 12 can contain a component used in internal electrode layers of multilayer ceramic capacitors. The internal electrode layer 12 may contain a base metal, such as nickel (Ni), tin (Sn), tungsten (W), or the like, or an alloy containing one or more selected from the group of these base metals, as a main component, i.e., in the highest amount by mole.

The internal electrode layer 12 may contain nickel, which has excellent electrical characteristics and is cost-saving, as a base metal element. The internal electrode layer 12 may contain nickel as a main component.

The main component of the first internal electrode layers 12a and the main component of the second internal electrode layers 12b may be the same as or different from each other. As an example, the main component of the first internal electrode layers 12a and the main component of the second internal electrode layers 12b may be the same and may both be nickel.

### (3-2) Thickness of Internal Electrode Layer

No particular limitation is imposed on the thickness of the internal electrode layer 12. From the viewpoint of increasing the electrostatic capacitance by increasing the number of layers to be laminated while reducing the size of the multilayer ceramic capacitor 100, the thickness of the internal electrode layer 12 is preferably, for example, 0.8 μm or less, and more preferably 0.6 μm or less.

No particular limitation is imposed on the lower limit of the thickness of the internal electrode layer 12, and the lower limit may be 0.4 μm or greater in a case of forming the internal electrode layer, for example, by printing a metal conductive paste by a printing method, such as screen printing, gravure printing, or the like. In the case of forming the internal electrode layer by a thin film process, such as sputtering, vapor deposition, or the like, the lower limit of the thickness can be 0.1 μm or greater, which is thinner than in the case of the printing method. When evaluating the thickness of the internal electrode layer 12, the thickness is evaluated using the cross section including the first axis that is equal to the lamination direction as in the evaluation of the thickness of the dielectric layer 11. For example, it is preferable to perform evaluation using either a cross section further including the second axis set perpendicularly to the lamination direction, or a cross section further including the third axis set perpendicularly to the lamination direction and perpendicularly to the second axis, for ease with polishing and measurement.

Five layers are selected from each of a center part, an upper end part, and a lower end part of the exposed internal electrode layers 12 in the first axis direction. When the number of internal electrode layers 12 is even, six layers are selected from the center part. Then, the thickness of each selected internal electrode layer 12 is measured at a total of three positions, namely, a center part, a left end part, and a right end part, and the average value of the measured thicknesses is used as the thickness of each internal electrode layer 12. Furthermore, the average value of the thicknesses of all selected and evaluated internal electrode layers 12 can be used as the thickness of the internal electrode layers 12 in the multilayer ceramic capacitor 100.

The examples illustrated in FIGS. 1 and 2, in which the first axis along the lamination direction is in the Z-axis direction, are examples in which the multilayer ceramic capacitor 100 is polished along the Y axis, i.e., the third axis, to expose an XZ surface in which the dielectric layers 11 and the internal electrode layers 12 are laminated.

In this case, five internal electrode layers 12 located at the center along the Z axis, i.e., the first axis, and five internal electrode layers 12 located at each of the upper end and the lower end along the Z axis, i.e., the first axis, are selected from the exposed XZ surface. When the number of internal electrode layers 12 is even, six layers may be selected from the center part. In this case, the internal electrode layers 12 to be selected are selected from within the capacitor portion 14.

Then, the thickness of each selected internal electrode layer 12 is measured along the X-axis, which is the second axis, at three positions spaced apart from an end by ¼, ½, and ¾ the length of the internal electrode layer 12 along the X axis, and is averaged as the thickness of the internal electrode layer 12. The thicknesses of all the selected internal electrode layers 12 are measured by the same procedure, and the average value of the thicknesses of all the selected and evaluated internal electrode layers 12 can be used as the thickness of the internal electrode layers 12 in the evaluated multilayer ceramic capacitor 100.

### (4) Side Margin

The side margins 16 can contain a ceramic material as a main component, and can also contain a component different from the main component. For example, a composition of the side margin 16 may be the same as or different from that of the dielectric layers 11.

### (4-1) Secondary Phase

As illustrated in FIGS. 3 and 4, the side margins 16 can include secondary phases 41 connecting an outer surface 14a and an outer surface 14b of the capacitor portion 14, in which the internal electrode layers 12 and the dielectric layers 11 are alternately laminated, to a third side surface 10c and a fourth side surface 10d, which are the outer surfaces of the side margins 16. The secondary phases 41 can connect the outer surface 14a of the capacitor portion 14 to the third side surface 10c, or can connect the outer surface 14b of the capacitor portion 14 to the fourth side surface 10d.

FIG. 4 corresponds to an enlarged diagram of a region C in FIG. 3, i.e., a partial enlarged diagram of the side margin 16. As described below, the side margin 16 may include secondary phases having a composition different from that of the dielectric material in addition to the dielectric material. The secondary phases may be identified based on the difference in brightness through SEM analysis. Alternatively, the secondary phases may be identified based on regions where characteristically contained elements (described below) in the secondary phases are concentrated in an element map obtained through SEM-EDS analysis.

The inventors of the present invention made studies on a multilayer ceramic electronic component having a low crack forming rate even after operation with a voltage applied. As a result, the inventors of the present invention have found out a structure in which the side margins 16 include the secondary phases 41 connecting the outer surfaces of the capacitor portion 14, in which the internal electrode layers 12 and the dielectric layers 11 are alternately laminated, to the outer surfaces of the side margins 16. The inventors of the present invention have found that such a structure can reduce the crack forming rate even after operation with a voltage applied. Based on this finding, the present invention has been completed.

In the present specification, the low crack forming rate even after operation with a voltage applied means that the crack forming rate described in an evaluation method in Examples described below is 2% or less.

The secondary phases 41 are formed of a material different from the dielectric material or the like contained as the main component of the side margins 16. The secondary phases 41 may be, for example, an additive added along with a dielectric material or the like, serving as a raw material, at the time of firing of the side margins 16, or may be a reaction product of an additive and ceramic particles.

The secondary phases 41 may contain, for example, silicon (Si). The secondary phases 41 may contain, in addition to silicon (Si), one or more selected from lithium (Li), boron (B), calcium (Ca), magnesium (Mg), manganese (Mn), and molybdenum (Mo). The secondary phases 41 may further contain aluminum (Al).

The secondary phases 41 have flexibility. Thus, when the side margin 16 includes the secondary phases 41 connecting the outer surface of the capacitor portion 14 to the outer surface of the side margin 16, it is possible to absorb an external force applied to the side margin 16. This can enhance the mechanical strength of the side margin 16. Since the side margin 16 has the function of enhancing the mechanical strength of the body 10, the enhanced mechanical strength of the side margin 16 enhances the mechanical strength of the body 10 and the multilayer ceramic electronic component, thereby reducing crack formation even after operation with a voltage applied. The capacitor portion 14 means a region in which the internal electrode layers 12 and the dielectric layers 11 are alternately laminated. The outer surface of the side margin 16 means the third side surface 10c or the fourth side surface 10d.

Connecting the outer surface of the capacitor portion 14 to the outer surface of the side margin 16 also means that the secondary phases 41 are in contact with the third side surface 10c or the fourth side surface 10d, i.e., the outer surface of the side margin 16, and are in contact with either or both of the internal electrode layer 12 and the dielectric layer 11.

No particular limitation is imposed on the content of the secondary phases 41. The secondary phases may be contained in the side margin 16 in an amount larger than in the dielectric layer 11. The secondary phases being contained in the side margin 16 in an amount larger than in the dielectric layer 11 means that, in the cross section including the first axis, the total area of the secondary phases contained in the side margin 16 is larger than the total area of the secondary phases contained in the dielectric layer 11.

In the cross section including the first axis, i.e., the lamination direction, the total area of the secondary phases contained in the side margin 16 may be 1.2 times or more, 1.5 times or more, or 1.8 times or more larger than the total area of the secondary phases contained in the dielectric layer 11.

When the side margin 16 contains the secondary phases in an amount larger than in the dielectric layer 11, it is possible to especially reduce the crack forming rate after operation with a voltage applied.

Also, for example, the side margin 16 may contain, per 100 μm along the Z axis, i.e., the first axis, two or more, four or more, or five or more secondary phases connecting the outer surface of the capacitor portion 14, in which the internal electrode layers 12 and the dielectric layers 11 are alternately laminated, to the outer surface of the side margin 16. When the side margin 16 contains, per 100 μm along the Z axis, i.e., the first axis, two or more secondary phases connecting the outer surface of the capacitor portion 14 to the outer surface of the side margin 16, it is possible to especially reduce the crack forming rate after operation with a voltage applied.

No particular limitation is imposed on the upper limit of the number of the secondary phases, connecting the outer surface of the capacitor portion 14 to the outer surface of the side margin 16, contained in the side margin 16 per 100 μm along the Z axis, i.e., the first axis. Inclusion of an excessively large number of the secondary phases can reduce productivity. Therefore, the number of the secondary phases, connecting the outer surface of the capacitor portion 14 to the outer surface of the side margin 16, contained in the side margin 16 per 100 μm along the Z axis, i.e., the first axis, may be 20 or less, or may be 15 or less.

### (4-2) Thickness of Side Margin

In recent years, there is a need for improvement in the electrostatic capacitance of a multilayer ceramic electronic component, and thus there is a need for reduction in the thickness of the side margin 16.

However, reducing the thickness of the side margin 16 reduces the mechanical strength of the multilayer ceramic electronic component, and thus easily causes formation of cracks.

In the multilayer ceramic electronic component of the present embodiment, the side margin 16 includes the predetermined secondary phases 41, and thus can enhance the mechanical strength of the multilayer ceramic electronic component. This effect is remarkably exhibited when the thickness of the side margin 16 is reduced. Thus, in the multilayer ceramic electronic component of the present embodiment, the thickness of the side margin 16 is preferably reduced because the area occupied by the internal electrodes can be increased, i.e., the electrostatic capacitance can be increased. A thickness T16 of the side margin 16 may be less than 15 μm, 12 μm or less, or 10 μm or less.

No particular limitation is imposed on the lower limit of the thickness T16 of the side margin 16, and the thickness T16 may be, for example, 3 μm or greater, 5 μm or greater, or 7 μm or greater. When the thickness T16 of the side margin 16 is 3 μm or more, it is possible to prevent a short circuit due to the unintended exposure of the internal electrode layer 12.

The thickness T16 of the side margin 16 may have a predetermined relationship with the particle diameter in the secondary phase.

The thickness T16 of the side margin 16 may be D95 or less, where D95 denotes a cumulative 95% particle diameter counted from a small-particle-diameter side in a number-based particle size distribution of the secondary phases. That is, D95≥T16 may be true. Also, D90≥T16 may be true, and D80≥T16 may be true. D90 and D80 mean a cumulative 90% particle diameter and a cumulative 80% particle diameter, respectively, counted from the small-particle-diameter side in the number-based particle size distribution of the secondary phases.

When D95≥T16 is true, it is possible to increase the number of the secondary phases connecting the outer surface of the capacitor portion 14 to the outer surface of the side margin 16. Also, it is possible to especially reduce the crack forming rate after operation with a voltage applied.

The thickness T16 of the side margin 16 may be greater than D60, where D60 is a cumulative 60% particle diameter counted from the small-particle-diameter side in the number-based particle size distribution of the secondary phases. That is, D60<T16 may be true. Also, D65<T16 may be true, and D70<T16 may be true. D65 and D70 mean a cumulative 65% particle diameter and a cumulative 70% particle diameter, respectively, counted from the small-particle-diameter side in the number-based particle size distribution of the secondary phases.

When D60<T16 is true, it is possible to prevent exposure or the like of the secondary phases from the side margin 16. Also, it is possible to prevent an adverse influence on workability at the time of forming the external electrode or the like.

The thickness of the side margin 16 can be evaluated as a distance between the outer surface of the capacitor portion and the outer surface of the side margin 16 in a cross section further including the third axis set perpendicularly to the first axis, i.e., the lamination direction, and perpendicularly to the second axis.

Five layers are selected from each of the center part, the upper end part, and the lower end part, in the first axis direction, of the internal electrode layers 12 in the exposed cross section. When the number of the internal electrode layers 12 is even, six layers are selected from the center part. Then, since the ends of the selected internal electrode layers 12 form the outer surface of the capacitor portion 14, the distance between the ends of the selected internal electrode layers 12 and the third side surface 10c or the fourth side surface 10d, i.e., the outer surface of the side margin 16, is measured as the thickness T16 of the side margin 16. The distance between the ends of the internal electrode layers 12 and the outer surface of the side margin 16 means the shortest distance between the ends of the internal electrode layers 12 and the outer surface of the side margin 16.

The average value of the measured distances between all the ends of the internal electrode layers 12 and the third side surface 10c or the fourth side surface 10d, i.e., the outer surface of the side margin 16, can be used as the thickness of the side margin 16 in the multilayer ceramic capacitor 100.

In the examples illustrated in FIGS. 1 and 3, in which the first axis along the lamination direction is along the Z-axis direction, the multilayer ceramic capacitor 100 is polished along the X axis, i.e., the second axis, to expose a YZ surface in which the dielectric layers 11 and the internal electrode layers 12 are laminated.

In this case, from the exposed YZ surface, five internal electrode layers 12 located at the center along the Z axis, i.e., the first axis, and five internal electrode layers 12 located at each of the upper end and the lower end along the Z axis, i.e., the first axis, are selected. When the number of internal electrode layers 12 is even, six layers may be selected from the center part. In this case, the internal electrode layers 12 to be selected are selected from within the capacitor portion 14.

Then, for the selected internal electrode layers 12, the distances between the ends of the internal electrode layers 12 and the third side surface 10c or the fourth side surface 10d, i.e., the outer surface of the side margin 16, are measured along the Y axis, i.e., the third axis. By the same procedure, the distances between the ends of the selected internal electrode layers 12 and the third side surface 10c or the fourth side surface 10d, i.e., the outer surface of the side margin 16, are measured, and the average value of the measured distances can be used as the thickness T16 of the side margin 16.

The number-based particle size distribution of the secondary phases can be evaluated in a cross section further including the third axis set perpendicularly to the first axis along the lamination direction, and perpendicularly to the second axis.

Fifty or more and one-hundred or less secondary phases included in the side margin 16 in the exposed cross section are selected. The major axis diameters of the selected secondary phases are measured as the particle diameters of the secondary phases, and the number-based particle size distribution can be created. If the fifty or more and one-hundred or less secondary phases cannot be confirmed in the side margin 16 in a single cross section, evaluation can be performed using a plurality of cross sections, and thus the fifty or more and one-hundred or less secondary phases can be evaluated in total.

From the measured and obtained number-based particle size distribution, D95, i.e., the cumulative 95% particle diameter, D90, i.e., the cumulative 90% particle diameter, D80, i.e., the cumulative 80% particle diameter, D70, i.e., the cumulative 70% particle diameter, D65, i.e., the cumulative 65% particle diameter, and D60, i.e., the cumulative 60% particle diameter can be obtained.

### [Production Method of Multilayer Ceramic Capacitor]

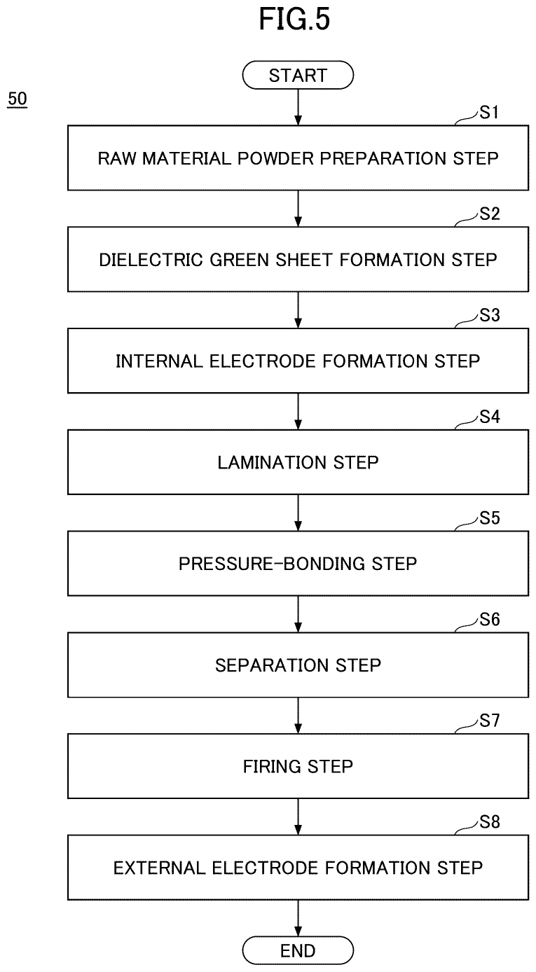

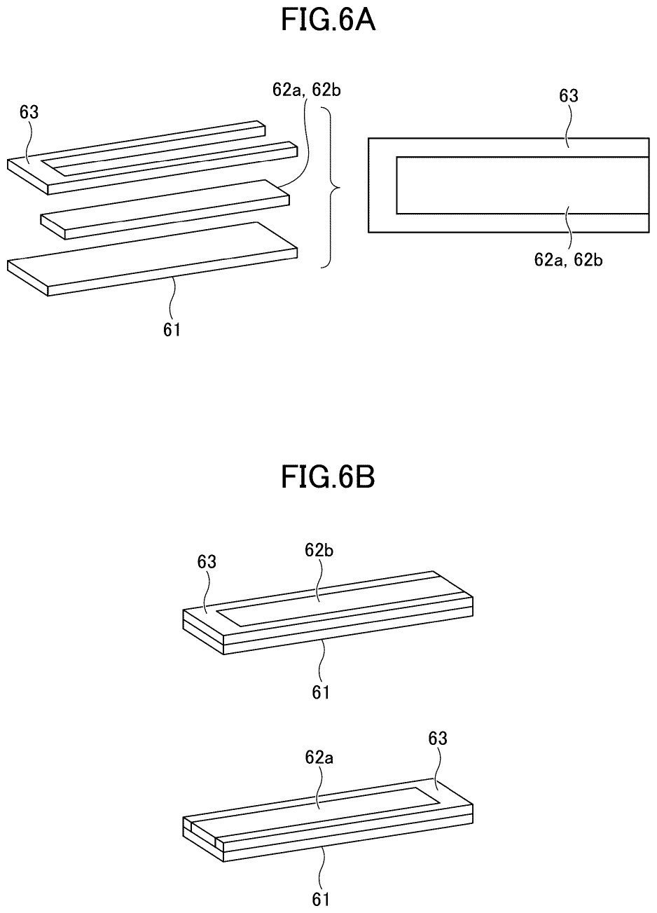

Next, a production method of the multilayer ceramic capacitor 100 will be described. FIG. 5 is a flowchart 50 illustrating the production method of the multilayer ceramic capacitor 100. FIGS. 6A and 6B are diagrams illustrating the production method of the multilayer ceramic capacitor 100.

The production method of the multilayer ceramic capacitor of the present embodiment may include a dielectric green sheet formation step, a thin film layer formation step, an internal electrode layer pattern formation step, and a firing step. The production method of the multilayer ceramic capacitor of the present embodiment, and optional steps other than the above steps will be described below.

### (1) Raw Material Powder Preparation Step (S1)

In the raw material powder preparation step, a raw material powder for forming the dielectric layers 11 can be prepared.

The dielectric layers 11 of the multilayer ceramic capacitor 100 produced by the production method of the multilayer ceramic capacitor of the present embodiment can contain a dielectric material that is a compound having a perovskite structure represented by the general formula ABO_{3-α} (0≤α≤1). The dielectric material, which is the compound having the perovskite structure represented by the general formula ABO_{3-α} (0≤α≤1), has already been described, and thus description thereof will be omitted.

The A-site element (A element) and the B-site element (B element) in the dielectric material contained in the dielectric layers 11 are typically contained in the dielectric layers 11 in the form of sintered bodies of particles of ABO_{3-α} (0≤α≤1). For example, barium titanate is a tetragonal compound having a perovskite structure, and exhibits a high relative dielectric constant. Barium titanate can be typically obtained through reaction between a titanium raw material, such as titanium dioxide or the like, and a barium raw material, such as barium carbonate or the like. Various methods have been known as a synthesis method of the dielectric material that can be used as the main component of the dielectric layers 11, such as a solid-phase method, a sol-gel method, a hydrothermal method, and the like. In the present embodiment, any of these methods can be employed.

In the raw material powder preparation step, a predetermined additive can be added to the dielectric material in accordance with the intended purpose. The additive also serves as the raw material for the secondary phase. Therefore, the additive in accordance with the intended composition of the secondary phases can be added to the dielectric material. The secondary phases may be contained only in the side margin 16, or may be contained in both the side margin 16 and the dielectric layer 11. Therefore, the additive may be added only to the raw material powder used for the side margin 16, or may be added to the raw material powders used for both the side margin 16 and the dielectric layer 11. The additive may be added to the raw material powder used for the side margin 16 in an amount larger than that in the raw material powder used for the dielectric layer 11, such that the secondary phases are contained in the side margin 16 in an amount larger than in the dielectric layer 11.

Examples of the additive include, for example: compounds, such as oxides and carbonates containing one or more elements selected from zirconium (Zr), magnesium (Mg), manganese (Mn), molybdenum (Mo), vanadium (V), chromium (Cr), and rare earth elements; compounds, such as oxides and carbonates containing one or more elements selected from cobalt (Co), nickel (Ni), lithium (Li), boron (B), sodium (Na), potassium (K), calcium (Ca), aluminum (Al), and silicon (Si); and glass containing one or more elements selected from cobalt, nickel, lithium, boron, sodium, potassium, and silicon.

Among the above-listed elements, the secondary phases contain silicon (Si), and may contain one or more selected from lithium (Li), boron (B), calcium (Ca), magnesium (Mg), manganese (Mn), and molybdenum (Mo). The secondary phases may also contain aluminum (Al). The elements listed here tend to be concentrated in the secondary phases after the formation of the secondary phase. Therefore, by assuming that a characteristic portion where the above elements are concentrated is the secondary phase, the secondary phases may be detected through elemental analysis by SEM-EDS.

The rare earth elements are, for example, one or more selected from scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb).

For example, the raw material powder can be prepared by wet-mixing the additive with the dielectric material, followed by drying and pulverizing. For example, if necessary, the raw material powder obtained in this manner may be subjected to a pulverizing treatment to adjust the particle diameter, or further to a classification treatment in combination to adjust the particle diameter. The raw material powder, i.e., a ceramic material, is obtained through this process.

### (2) Dielectric Green Sheet Formation Step (S2)

In the dielectric green sheet formation step, a binder, such as a polyvinyl butyral (PVB) resin or the like, an organic solvent, such as ethanol, toluene, or the like, and a plasticizer can be added to the raw material powder obtained in the raw material powder preparation step, followed by wet mixing, thereby forming a slurry. The binder or the like may be added simultaneously when mixing the raw material powder and the like in the raw material powder preparation step (S1), followed by wet mixing, thereby forming a slurry.

In the dielectric green sheet formation step, a dielectric green sheet 61 can be formed by applying the obtained slurry on a base, for example, by a die coater method or a doctor blade method, followed by drying. The base for use can be a polyethylene terephthalate (PET) film. A drawing illustrating the dielectric green sheet formation step is omitted.

Therefore, in the dielectric green sheet formation step (S2), a dielectric green sheet containing the additive and the compound having the perovskite structure represented by the general formula ABO_{3-α} (0≤α≤1) can be formed. As described above, the dielectric green sheet can contain the additive in addition to the compound having the perovskite structure represented by the above general formula.

### (3) Internal Electrode Layer Formation Step (S3)

The first internal electrode layers 12a and the second internal electrode layers 12b can contain, as a main component, one or more selected from base metals, such as nickel (Ni), tin (Sn), tungsten (W), and the like, and alloys containing these.

The main component of the first internal electrode layers 12a and the main component of the second internal electrode layers 12b may be the same as or different from each other. As an example, the main component of the first internal electrode layers 12a and the main component of the second internal electrode layers 12b may be the same and may both be nickel.

A metal conductive paste for forming a precursor of the first internal electrode layers 12a and the second internal electrode layers 12b may be prepared by kneading the selected main component, an organic binder, and a solvent.

In the internal electrode layer formation step, as illustrated in FIG. 6A, the metal conductive paste for internal electrode layer formation, containing an organic binder, can be printed on the surface of the dielectric green sheet 61 through screen printing, gravure printing, or the like. As the organic binder, for example, ethyl cellulose (EC), polyvinyl butyral (PVB) resin, or the like can be used. Thus, a first internal electrode layer pattern 62a for the first internal electrode layer 12a or a second internal electrode layer pattern 62b for the second internal electrode layer 12b is placed on the surface of the dielectric green sheet 61. Various auxiliary agents, such as a dispersant and the like, or ceramic particles serving as a co-existent material can also be added to the metal conductive paste. Although the main component of the ceramic particles is not particularly limited, the main component is preferably the same as the main component ceramic of the dielectric layer 11. When adding ceramic particles as a co-existent material, it is possible to add these during kneading of the metal conductive paste. The method for forming the internal electrode layer is not limited to printing, and plating, vacuum deposition, sputtering, or CVD may be used.

Also, it is possible to obtain a dielectric pattern paste for a reverse pattern layer by adding a binder, such as an ethyl cellulose-based binder or the like, and an organic solvent, such as terpineol-based organic solvent or the like, to the dielectric pattern material obtained in the raw material powder preparation step, followed by kneading using a roll mill. Then, as illustrated in FIG. 6A, a dielectric pattern 63 may be placed on the dielectric green sheet 61 by printing the dielectric pattern paste on a peripheral region where no internal electrode layer pattern is printed, to fill the gap from the internal electrode layer pattern. A portion of the dielectric pattern 63 forms into the side margin 16. Therefore, a component serving as the raw material for the secondary phases contained in the side margin 16 of the dielectric pattern 63 may be added. The dielectric pattern 63 may contain, for example, the additive described for the material of the dielectric layer. By including the additive in the dielectric pattern 63, the secondary phases can be deposited in the side margin 16 in the firing step, described below, or after the firing step. Also, particles corresponding to the secondary phases may be added to the dielectric pattern 63. The secondary phases may be contained only in the side margin 16, or may be contained in both the side margin 16 and the dielectric layer 11. The secondary phases may be contained in the side margin 16 in an amount larger than in the dielectric layer 11.

As described below, the side margin 16 may be formed after the firing step or before the firing step. The secondary phases may be contained only in the side margin 16, or may be contained in both the side margin 16 and the dielectric layer 11. Therefore, when the dielectric pattern 63 is placed by printing the dielectric pattern paste in a peripheral region where the internal electrode layer pattern is not printed, the additive may be added only to the raw material powder used for the dielectric pattern 63 to be a portion of the side margin 16, or may be added to the raw material powder used for both the side margin 16 and the dielectric layer 11. The additive may be added to the raw material powder used for the side margin 16 in an amount larger than that in the raw material powder used for the dielectric layer 11 such that the secondary phases are contained in the side margin 16 in an amount larger than in the dielectric layer 11.

The dielectric green sheet 61 on which the internal electrode layer pattern and the dielectric pattern 63 are printed is referred to as a lamination unit.

### (4) Lamination Step (S4)

In the lamination step, as illustrated in FIG. 6B, the lamination unit can be laminated such that the internal electrode layers and the dielectric layers are alternate and such that the edges of the internal electrode layers are exposed to the end surfaces of the dielectric layers on alternate sides in the length direction and drawn outward to alternate ones of a pair of external electrodes. Specifically, the dielectric green sheet 61 on which the first internal electrode layer pattern 62a and the dielectric pattern 63 are printed and the dielectric green sheet 61 on which the second internal electrode layer pattern 62b and the dielectric pattern 63 are printed are laminated in this order. For example, the number of lamination units to be laminated can be 100 or more and 500 or less.

### (5) Pressure-Bonding Step (S5)

In the pressure-bonding step, the laminate in which the lamination units are laminated can be thermally pressure-bonded, with a predetermined number of, for example, two to ten, layers of cover sheets laminated on top and bottom of the laminate.

### (6) Separation Step (S6)

In the separation step, the pressure-bonded body obtained through pressure-bonding can be separated into individual pieces, to obtain separated laminates. Existing methods, such as dicing by a dicer, laser cutting, and the like can be used as appropriate as the separation method.

### (7) Firing Step (S7)

In the firing step, the separated laminates can be debound and fired. In the firing step, degreasing treatment and firing treatment may be performed continuously or separately. No particular limitation is imposed on degreasing and firing conditions. For example, degreasing may be performed in a nitrogen atmosphere at 250° C. or higher and 500° C. or lower.

Firing may be performed for five minutes or more and ten hours or less in a weakly oxidizing atmosphere in which the oxygen partial pressure is 10⁻¹² atm or higher and 10⁻⁸ atm or lower in a temperature range of 1,100° C. or higher and 1, 350° C. or lower, or in a reducing atmosphere. Preferably, the oxygen partial pressure may be 10⁻¹² atm or higher and 10⁻¹⁰ atm or lower.

When using a reducing atmosphere, one or more selected from hydrogen and carbon monoxide can be used as the reducing gas. The reducing gas may be used as a gas mixture with an inert gas, such as nitrogen or the like, or with a noble gas. Examples of the noble gas include helium, argon, and the like.

The temperature range during firing may preferably be 1, 150° C. or higher and 1, 350° C. or lower. The firing time may preferably be 5 minutes or more and less than 15 minutes.

### (8) External Electrode Formation Step (S8)

In the external electrode formation step, an external electrode can be formed by forming a metal conductive paste for external electrode layer formation, containing a main component base metal, such as nickel and the like, metals, such as copper and the like, and an organic binder, through screen printing, dipping, or the like, and then baking the paste. The formation method of the external electrode is not limited to printing or dipping, and plating, vacuum deposition, sputtering, or CVD may be used. Alternatively, an external electrode may be formed by printing and applying a conductive resin paste through screen printing, dipping, or the like, and curing the resin. If necessary, a layer of copper, nickel, or tin may be formed by plating and the like. Thus, the first external electrode 20a and the second external electrode 20b can be formed. The multilayer ceramic capacitor 100 can be produced through the above steps.

### (9) Side Margin Formation Step

As an optional step, the production method of the multilayer ceramic electronic component of the present embodiment may include a side margin formation step. In this case, in the dielectric green sheet formation step (S2) and the internal electrode layer formation step (S3), it is preferable to form the members in portions other than the portions to be the side margin, such as a portion of the dielectric green sheet, the dielectric pattern 63, and the like.

In the side margin formation step, a side margin forming paste can be prepared by adding a binder, such as an ethyl cellulose-based binder or the like, and an organic solvent, such as a terpineol-based organic solvent or the like, to the dielectric pattern material obtained by adding the additive to the raw material powder obtained in the raw material powder preparation step.

Since the dielectric layer 11 can be free from the secondary phase, the additive may be added only to the raw material powder used in the side margin formation step, i.e., the additive is not added to the raw material powder used in the dielectric green sheet formation step (S2). Also, the additive may be added to the raw material powder used in the side margin formation step in an amount larger than that in the raw material powder used in the dielectric green sheet formation step (S2) such that the secondary phases are contained in the side margin 16 in an amount larger than in the dielectric layer 11. Then, the side margin forming paste can be applied or the like to a portion corresponding to the side margin of the laminate separated in the separation step (S6). After the side margin formation step, the laminate can be subjected to the firing step.

In addition, the side margin can also be formed by applying the side margin forming paste to the portion corresponding to the side margin of the laminate after the firing step, followed by firing if necessary.

Particles to be the secondary phases may be previously added to the side margin forming paste, and arrangement of the particles to be the secondary phases may be adjusted by selecting conditions for printing and coating the paste on the laminate. Specifically, for example, particle size characteristics can be selected such that the maximum particle diameter in the number-based particle size distribution of particles to be the secondary phases is equal to or greater than the thickness of the side margin 16. The particle diameter and the maximum particle diameter mean the major axis diameter of the particles to be the secondary phase. Thus, particles enough to form the thickness of the side margin can be placed to contact the outer surface of the capacitor portion of the laminate. Therefore, it is possible to place the secondary phases connecting the outer surface of the capacitor portion to the outer surface of the side margin.

Alternatively, the particles to be the secondary phases may be arranged to connect the outer surface of the capacitor portion of the laminate to the outer surface of the side margin through printing, or through printing or coating of the side margin forming paste via a slit.

The number of particles to be the secondary phase, connecting the outer surface of the capacitor portion of the laminate to the outer surface of the side margin, preferably increases as the distribution ratio of particles larger than the thickness of the side margin increases in the particle size distribution of the particles to be the secondary phase. For example, the thickness T16 of the side margin 16 may be D95 or less, where D95 denotes a cumulative 95% particle diameter counted from the small-particle-diameter side in the number-based particle size distribution of the particles to be the secondary phase. That is, D95≥T16 may be true. Also, D90≥T16 may be true, and D80≥T16 may be true. D90 and D80 mean a cumulative 90% particle diameter and a cumulative 80% particle diameter, respectively, counted from the small-particle-diameter side in the number-based particle size distribution of the particles to be the secondary phase.

In the formation of the side margin, when the particles to be the secondary phases are larger than the thickness of the side margin, the particles to be the secondary phases rotate as illustrated in FIG. 4, and can partially intrude into the capacitor portion of the laminate.

When particles to be the secondary phases are excessively larger than the thickness of the side margin, such particles may project beyond the outer surface of the side margin, and thus can adversely influence workability, for example, at the time of forming the external electrode. Therefore, the thickness of the side margin 16 may be larger than D60, where D60 denotes a cumulative 60% particle diameter counted from the small-particle-diameter side in the number-based particle size distribution of the particles to be the secondary phases. That is, D60<T16 may be true. Also, D65<T16 may be true, or D70<T16 may be true. D65 and D70 mean a cumulative 65% particle diameter and a cumulative 70% particle diameter, respectively, counted from the small-particle-diameter side in the number-based particle size distribution of the particles to be the secondary phase.

When measuring the number-based particle size distribution of the particles to be the secondary phase, fifty or more and one-hundred or less particles to be the secondary phases are selected. Then, the major axis diameters of the selected particles to be the secondary phases are measured as the particle diameters of the particles to be the secondary phases, and the number-based particle size distribution of the particles can be created.

From the measured and obtained number-based particle size distribution, D95, i.e., the cumulative 95% particle diameter, D90, i.e., the cumulative 90% particle diameter, D80, i.e., the cumulative 80% particle diameter, D70, i.e., the cumulative 70% particle diameter, D65, i.e., the cumulative 65% particle diameter, and D60, i.e., the cumulative 60% particle diameter can be obtained.

When the additive is added to a portion to be the side margin to form the secondary phases in the firing step, the arrangement of the particles to be the secondary phases in the side margin may be adjusted by selecting the type and amount of the additive, the firing conditions for the firing step, and the like.

The above steps are an example, and the production method of the multilayer ceramic capacitor of the present embodiment is not limited to the above embodiment. For example, a base layer for an external electrode may be provided on a surface of a separated laminate, and baked simultaneously with firing of the ceramic, to form a base layer. In this case, in the external electrode formation step after firing, the external electrode is firmed by forming a layer of copper, nickel, or tin on the base layer through plating.

### Other Embodiments

Although the above-described embodiments have been described in detail, the present disclosure is not limited to the specific embodiments, and various modifications and changes are applicable within the scope of description in the claims.

For example, the above-described embodiments are applied to a multilayer ceramic capacitor having two terminal electrodes. However, they may also be applied to a multilayer ceramic capacitor having three or more terminals.

### EXAMPLES

The present disclosure will be described below in detail by way of specific examples. However, the present disclosure is not limited to these examples.

### (1) Evaluation Method

### (1-1) Presence or Absence of Secondary Phases Connecting Outer Surface of Capacitor Portion to Outer Surface of Side Margin

Each of the multilayer ceramic capacitors produced in Examples and a Comparative Example was cut to expose a cross section along the line B-B in FIG. 1. The side margin 16 in the exposed cross section was observed through SEM to observe secondary phases different from the dielectric material. When the secondary phases were found, the presence or absence of the secondary phases connecting the outer surface of the capacitor portion to the outer surface of the side margin was confirmed. The presence of the secondary phases connecting the outer surface of the capacitor portion to the outer surface of the side margin was evaluated as “Present”, and the absence of the secondary phases connecting the outer surface of the capacitor portion to the outer surface of the side margin was evaluated as “Absent”.

### (1-2) Number of Secondary Phases, Connecting Outer Surface of Capacitor Portion to Outer Surface of Side Margin, Contained Per 100 μm Along First Axis

When the evaluation in “(1-1) Presence or absence of secondary phases connecting outer surface of capacitor portion to outer surface of side margin” was “Present”, the number of the secondary phases, connecting the outer surface of the capacitor portion to the outer surface of the side margin, contained per 100 μm along the first axis was counted.

Specifically, from the cross section under SEM observation, six evaluation regions having a length of 100 μm along the first axis were selected to avoid being overlapped. In each evaluation region, the number of the secondary phases connecting the outer surface of the capacitor portion to the outer surface of the side margin was counted. Then, an arithmetic mean value of the number of the secondary phases measured in each evaluation region was defined as the number of the secondary phases, connecting the outer surface of the capacitor portion to the outer surface of the side margin, contained per 100 μm along the first axis in the evaluated multilayer ceramic capacitor.

### (1-3) Crack Forming Rate, and Determination

In each of Examples and a Comparative Example, one-hundred multilayer ceramic capacitors produced under the same conditions were mounted on a substrate, placed in a thermostatic bath at 125° C., and allowed to receive application of a voltage for 1,000 hours that was adjusted such that the electric field intensity in the dielectric layer would be 15 V/μm. After the application of the voltage, the surface of the multilayer ceramic capacitor was visually confirmed to evaluate the presence or absence of cracks.

The number of multilayer ceramic capacitors in which cracks were formed among the one-hundred multilayer ceramic capacitors was determined as the crack forming rate.

The crack forming rate of 0% or more and 0.5% or less was evaluated as “A”, the crack forming rate of more than 0.5% and 2% or less was evaluated as “B”, and the crack forming rate of more than 2% was evaluated as “C”.

The evaluation “A” indicates that the crack forming rate can be reduced the most significantly. The crack forming rate is lower in the evaluation “B” than in the evaluation “C”. The multilayer ceramic capacitors evaluated as “A” or “B” are multilayer ceramic capacitors having a low crack forming rate.

### (2) Sample Preparation Conditions

### Example 1

### (2-1) Raw Material Powder Preparation Step

A multilayer ceramic capacitor was produced in accordance with the flowchart 50 illustrated in FIG. 5.

Specifically, first, a dielectric pattern material was prepared by mixing a barium titanate powder with additives, i.e., holmium oxide (Ho₂O₃), magnesium oxide (MgO), manganese carbonate (MnCO₃), and silicon oxide (SiO₂). A slurry was obtained by wet-mixing the dielectric pattern material, a polyvinyl butyral (PVB) resin, a solvent, a plasticizer, and a dispersant.

### (2-2) Dielectric Green Sheet Formation Step

The obtained slurry was applied to a base film, and the slurry applied to the base film was dried to obtain a dielectric green sheet.

### (2-3) Internal Electrode Layer Formation Step

Next, a powder of nickel, serving as a main component metal element, was wet-mixed with ethyl cellulose (EC), a polyvinyl butyral (PVB) resin, or the like, serving as a binder, a solvent, and a plasticizer, to obtain a metal conductive paste for internal electrode layer formation. Then, the metal conductive paste was printed on a partial region of the surface of the dielectric green sheet, to form an internal electrode layer pattern containing nickel, serving as a main component base metal element, on each dielectric green sheet.

### (2-4) Reverse Pattern Dielectric Layer Formation Step

Next, silicon oxide (SiO₂), aluminum oxide (Al₂O₃), a binder, such as an ethyl cellulose-based binder or the like, and an organic solvent, such as a terpineol-based organic solvent or the like were added to the dielectric pattern material obtained in the raw material powder preparation step, followed by kneading using a roll mill. By the above procedure, a dielectric pattern paste for a reverse pattern layer was obtained. Then, as illustrated in FIG. 6A, the dielectric pattern 63 was placed on the dielectric green sheet 61 by printing the dielectric pattern paste on a peripheral region where no internal electrode layer pattern was printed, to form a reverse pattern dielectric layer.

A lamination unit was produced through the dielectric green sheet formation step, the internal electrode layer formation step, and the reverse pattern dielectric layer formation step, as described above. The obtained lamination unit had: the dielectric green sheet; and the internal electrode layer pattern and the dielectric pattern that were formed on the surface of the dielectric green sheet.

### (2-5) Lamination Step

Next, five-hundred lamination units were laminated to form a laminate.

### (2-6) Pressure-Bonding Step and Separation Step

Then, the laminate was subjected to pressure-bonding and then separated, to obtain a chip-shaped green laminate.

### (2-7) Firing Step

Next, the chip-shaped green laminate was debound in a nitrogen atmosphere at 500° C.

As a base layer, a metal conductive paste containing a metal filler containing nickel as a main component, a co-existent material, a binder, a solvent, and the like was applied to the green laminate after being debound, from both end surfaces to each side surface thereof, followed by drying. Subsequently, the green laminate to which the base layer for external electrodes was applied was put into a firing furnace and fired.

In the firing step, the green laminate was retained at a firing temperature of 1,220° C., as shown in Table 1, for 300 seconds in a reducing atmosphere, which was a mixed atmosphere of hydrogen and nitrogen, and in which the oxygen partial pressure was 1.0×10⁻¹⁰ atm. When increasing the temperature, the amount of green laminates to be fed and the oxygen partial pressure were adjusted to avoid a sudden change in the firing atmosphere due to gas that might be generated from the green laminates and to prevent cracking of the fired products.

### (2-8) External Electrode Formation Step

The first external electrode 20a and the second external electrode 20b were formed on the fired laminate through plating.

The resulting multilayer ceramic capacitor had a chip shape of 1.0 mm×0.5 mm×0.5 mm, the thickness of the dielectric layers 11 was 0.8 μm, the thickness of the internal electrode layers 12 was 0.6 μm, and the number of layers laminated was 500. The thicknesses of the dielectric layers 11 and the internal electrode layers 12 were evaluated by the procedure described above.

The obtained multilayer ceramic capacitor was evaluated in terms of the items described above. The evaluation results are shown in Table 1.

### Example 2

In the reverse pattern dielectric layer formation step, silicon oxide (SiO₂), aluminum oxide (Al₂O₃), calcium carbonate (CaCO₃), a binder, such as an ethyl cellulose-based binder or the like, and an organic solvent, such as a terpineol-based organic solvent or the like were added to the dielectric pattern material obtained in the raw material powder preparation step, followed by kneading using a roll mill. By the above procedure, a dielectric pattern paste for a reverse pattern layer was obtained. Then, as illustrated in FIG. 6A, the dielectric pattern 63 was placed on the dielectric green sheet 61 by printing the dielectric pattern paste on a peripheral region where no internal electrode layer pattern was printed, to form a reverse pattern dielectric layer.

Except for the above, a multilayer ceramic capacitor was produced by the same procedure as in Example 1, and was evaluated. The evaluation results are shown in Table 1.

### Example 3

In the reverse pattern dielectric layer formation step, silicon oxide (SiO₂), aluminum oxide (Al₂O₃), manganese carbonate (MnCO₃), a binder, such as an ethyl cellulose-based binder or the like, and an organic solvent, such as a terpineol-based organic solvent or the like were added to the dielectric pattern material obtained in the raw material powder preparation step, followed by kneading using a roll mill. By the above procedure, a dielectric pattern paste for a reverse pattern layer was obtained. Then, as illustrated in FIG. 6A, the dielectric pattern 63 was placed on the dielectric green sheet 61 by printing the dielectric pattern paste on a peripheral region where no internal electrode layer pattern was printed, to form a reverse pattern dielectric layer.

Except for the above, a multilayer ceramic capacitor was produced by the same procedure as in Example 1, and was evaluated. The evaluation results are shown in Table 1.

### Example 4

In the reverse pattern dielectric layer formation step, silicon oxide (SiO₂), aluminum oxide (Al₂O₃), magnesium oxide (MgO), a binder, such as an ethyl cellulose-based binder or the like, and an organic solvent, such as a terpineol-based organic solvent or the like were added to the dielectric pattern material obtained in the raw material powder preparation step, followed by kneading using a roll mill. By the above procedure, a dielectric pattern paste for a reverse pattern layer was obtained. Then, as illustrated in FIG. 6A, the dielectric pattern 63 was placed on the dielectric green sheet 61 by printing the dielectric pattern paste on a peripheral region where no internal electrode layer pattern was printed, to form a reverse pattern dielectric layer.

Except for the above, a multilayer ceramic capacitor was produced by the same procedure as in Example 1, and was evaluated. The evaluation results are shown in Table 1.

### Example 5

In the reverse pattern dielectric layer formation step, silicon oxide (SiO₂), aluminum oxide (Al₂O₃), lithium carbonate (Li₂CO₃), a binder, such as an ethyl cellulose-based binder or the like, and an organic solvent, such as a terpineol-based organic solvent or the like were added to the dielectric pattern material obtained in the raw material powder preparation step, followed by kneading using a roll mill. By the above procedure, a dielectric pattern paste for a reverse pattern layer was obtained. Then, as illustrated in FIG. 6A, the dielectric pattern 63 was placed on the dielectric green sheet 61 by printing the dielectric pattern paste on a peripheral region where no internal electrode layer pattern was printed, to form a reverse pattern dielectric layer.

Except for the above, a multilayer ceramic capacitor was produced by the same procedure as in Example 1, and was evaluated. The evaluation results are shown in Table 1.

### Example 6

In the reverse pattern dielectric layer formation step, silicon oxide (SiO₂), aluminum oxide (Al₂O₃), boron nitride (BN), a binder, such as an ethyl cellulose-based binder or the like, and an organic solvent, such as a terpineol-based organic solvent or the like were added to the dielectric pattern material obtained in the raw material powder preparation step, followed by kneading using a roll mill. By the above procedure, a dielectric pattern paste for a reverse pattern layer was obtained. Then, as illustrated in FIG. 6A, the dielectric pattern 63 was placed on the dielectric green sheet 61 by printing the dielectric pattern paste on a peripheral region where no internal electrode layer pattern was printed, to form a reverse pattern dielectric layer.

Except for the above, a multilayer ceramic capacitor was produced by the same procedure as in Example 1, and was evaluated. The evaluation results are shown in Table 1.

### Comparative Example 1

No additives were added in the raw material powder preparation step. Except for this, a multilayer ceramic capacitor was produced by the same procedure as in Example 1, and was evaluated. The evaluation results are shown in Table 1.

TABLE 1

| | | | Crack | |
|---|---|---|---|---|
| | Presence or absence of secondary phase | Number of secondary phases, connecting outer | forming | |
| | connecting outer surface of capacitor | surface of capacitor portion to outer surface of | rate | |
| | portion to outer surface of side margin | side margin, contained per 100 μm along first axis | (%) | Evaluation |
| Example 1 | Present | 4 | 1.0 | B |
| Example 2 | Present | 6 | 0.0 | A |
| Example 3 | Present | 10 | 0.0 | A |
| Example 4 | Present | 9 | 0.0 | A |
| Example 5 | Present | 2 | 1.5 | B |
| Example 6 | Present | 5 | 0.5 | A |
| Comparative | Absent | Absent | 5.0 | C |
| Example 1 | | | | |

According to Table 1, in Examples 1 to 6 in which the secondary phases connecting the internal electrode layers to the outer surface of the side margin was confirmed, the crack forming rate was 2% or less, indicating that the multilayer ceramic capacitors having a low crack forming rate were obtained.

The embodiments of the present disclosure are, for example, as follows.

<1> A multilayer ceramic electronic component, including:
a body including a plurality of dielectric layers and a plurality of internal electrode layers that are alternately laminated along a first axis, wherein
the internal electrode layers are drawn outward from both ends of the body along a second axis orthogonal to the first axis,
the body includes side margins at both ends of the body along a third axis orthogonal to the first axis and the second axis,
at least one of the side margins includes one or more secondary phases connecting an outer surface of a capacitor portion to an outer surface of the at least one of the side margins, and
the capacitor portion includes the internal electrode layers and the dielectric layers that are alternately laminated.

<2> The multilayer ceramic electronic component according to <1>, wherein
the at least one of the side margins includes two or more secondary phases per 100 μm along the first axis, and
each of the two or more secondary phases connects the outer surface of the capacitor portion to the outer surface of the at least one of the side margins.

<3> The multilayer ceramic electronic component according to <1> or <2>, wherein
the at least one of the side margins includes the secondary phases in an amount larger than in the dielectric layers.

<4> The multilayer ceramic electronic component according to any one of <1> to <3>, wherein
in a cross section of the multilayer ceramic electronic component including the first axis, a total area of the secondary phases included in the at least one of the side margins is 1.2 times or more larger than a total area of the secondary phases included in the dielectric layers.

<5> The multilayer ceramic electronic component according to any one of <1> to <4>, wherein
a thickness of the at least one of the side margins is equal to or less than a cumulative 95% particle diameter counted from a small-particle-diameter side in a number-based particle size distribution of the secondary phases.

<6> The multilayer ceramic electronic component according to any one of <1> to <5>, wherein
a thickness of the at least one of the side margins is greater than a cumulative 60% particle diameter counted from a small-particle-diameter side in a number-based particle size distribution of the secondary phases.

<7> The multilayer ceramic electronic component according to any one of <1> to <6>, wherein
a thickness of the at least one of the side margins is 10 μm or less.

<8> The multilayer ceramic electronic component according to any one of <1> to <7>, wherein
the dielectric layers include a compound having a perovskite structure represented by general formula ABO_{3-α} (0≤α≤1), where A and B denote an element located at an A site and an element located at a B site, respectively, and
the internal electrode layers include a base metal element as a main component.

What is claimed is:

1. A multilayer ceramic electronic component, comprising:
a body including a plurality of dielectric layers and a plurality of internal electrode layers that are alternately laminated along a first axis, wherein
the internal electrode layers are drawn outward from both ends of the body along a second axis orthogonal to the first axis,
the body includes side margins at both ends of the body along a third axis orthogonal to the first axis and the second axis,
at least one of the side margins includes one or more secondary phases connecting an outer surface of a capacitor portion to an outer surface of the at least one of the side margins, and
the capacitor portion includes the internal electrode layers and the dielectric layers that are alternately laminated.

2. The multilayer ceramic electronic component according to claim 1, wherein
the at least one of the side margins includes two or more secondary phases per 100 μm along the first axis, and
each of the two or more secondary phases connects the outer surface of the capacitor portion to the outer surface of the at least one of the side margins.

3. The multilayer ceramic electronic component according to claim 2, wherein
the at least one of the side margins includes the secondary phases in an amount larger than in the dielectric layers.

4. The multilayer ceramic electronic component according to claim 1, wherein
in a cross section of the multilayer ceramic electronic component including the first axis, a total area of the secondary phases included in the at least one of the side margins is 1.2 times or more larger than a total area of the secondary phases included in the dielectric layers.

5. The multilayer ceramic electronic component according to claim 1, wherein
a thickness of the at least one of the side margins is equal to or less than a cumulative 95% particle diameter counted from a small-particle-diameter side in a number-based particle size distribution of the secondary phases.

6. The multilayer ceramic electronic component according to claim 1, wherein
a thickness of the at least one of the side margins is greater than a cumulative 60% particle diameter counted from a small-particle-diameter side in a number-based particle size distribution of the secondary phases.

7. The multilayer ceramic electronic component according to claim 1, wherein
a thickness of the at least one of the side margins is 10 μm or less.

8. The multilayer ceramic electronic component according to claim 1, wherein
the dielectric layers include a compound having a perovskite structure represented by general formula ABO_{3-α} (0≤α≤1), where A and B denote an element located at an A site and an element located at a B site, respectively, and
the internal electrode layers include a base metal element as a main component.
